(19) United States
(12) Patent Application Publication
(10) Pub. No.: US 2018/0107601 A1
(43) Pub. Date: Apr. 19, 2018

(54) CACHE ARCHITECTURE AND ALGORITHMS FOR HYBRID OBJECT STORAGE DEVICES

(71) Applicant: Agency for Science, Technology and Research, Singapore (SG)

(72) Inventors: Chao Jin, Singapore (SG); Weiya Xi, Singapore (SG); Khai Leong Yong, Singapore (SG); Zhi Yong Ching, Singapore (SG)

(21) Appl. No.: 15/567,295

(22) PCT Filed: May 20, 2016
(86) PCT No.: PCT/SG2016/050240

§ 371 Date: Oct. 17, 2017

(30) Foreign Application Priority Data
May 21, 2015 (SG) 10201504018Y

(51) Int. Cl. G06F 12/0866; G06F 3/06

(52) U.S. Cl. CPC G06F 12/0866; G06F 3/068; G06F 2212/205; G06F 2212/314; G06F 2212/1016

(57) ABSTRACT

A method for data storage in a hybrid storage node of a data storage system is provided. The hybrid storage node includes first and second storage devices having different performance characteristics wherein the first devices includes at least one high performance non-volatile memory for cache storage. The hybrid storage node further includes processing resources for managing data storage in the hybrid storage node. The method includes receiving a read request to read stored information from the hybrid storage node and, in response to the read request, accessing both the cache storage first storage devices and storage in the second storage devices to locate the stored information.

### TECHNICAL FIELD

The present invention generally relates to methods and systems for data storage, and more particularly relates to methods and systems for data system management.

### BACKGROUND OF THE DISCLOSURE

With the advancement of central processing unit and non-volatile memory technologies, it is increasingly feasible to incorporate functionalities of operating system software and storage system software into small storage controller boards to optimize storage system performance and reduce Total Ownership Cost (TOC).

In next-generation storage systems, the storage servers and redundant array of independent disk (RAID) controllers used to manage storage devices have been removed. Instead, single system-on-ship (SOC) active drive controllers are used to manage a storage node, shifting the functions of storage servers to the storage devices. Applications can directly connect to storage devices thereby greatly reducing whole system cost including hardware cost and maintenance cost.

Such hybrid technology solutions combine different storage media in a single storage device to simultaneously improve storage performance (measured as input/output operations per second (IOPS) per dollar (IOPS/$)) and reduce storage cost (measured as dollar per Gigabyte ($/GB)). As different storage media have different performance characteristics and different costs, a hybrid storage device normally consists of a small amount of high performance and high cost storage media with a large amount of low performance and low cost storage media. For example, a hybrid storage device could be a hybrid drive containing non-volatile random access memory (NVRAM) semiconductor chips and magnetic disk platters inside a single disk enclosure. A hybrid storage device could also be a storage node consisting of single/multiple solid state devices (SSDs) and single/multiple hard disk drives (HDDs). The number of SSDs and HDDs used in such a node could be determined based on desired performance or cost.

In order to take full advantage of the different storage media in such hybrid storage devices, efficient data management and cache algorithms are required and special requirements need to be considered. First, since the hybrid storage devices in such system are directly attached to the network, and are often managed by a distributed file or object storage system, it is more efficient for hybrid data management and cache algorithms to be designed and implemented at the file or object level. Second, as the hybrid storage devices usually have limited hardware resources, it is critical that the cache architecture and algorithms designed for such systems should be highly efficient and less resource demanding.

Thus, what is needed is methods and systems for efficient hybrid data management and cache algorithms which at least partially overcome the drawbacks of present approaches and provide minimal resource usage solutions for effective use in future storage systems. Furthermore, other desirable features and characteristics will become apparent from the subsequent detailed description and the appended claims, taken in conjunction with the accompanying drawings and this background of the disclosure.

### SUMMARY

According to at least one embodiment of the present invention a method for data storage in a hybrid storage node of a data storage system is provided. The hybrid storage node includes first and second storage devices having different performance characteristics wherein the first devices includes at least one high performance non-volatile memory for cache storage. The hybrid storage node further includes processing resources for managing data storage in the hybrid storage node. The method includes receiving a read request to read stored information from the hybrid storage node and, in response to the read request, accessing both the cache storage first storage devices and storage in the second storage devices to locate the stored information.

According to another embodiment of the present invention a data storage system comprising one or more hybrid storage nodes is provided. Each hybrid storage node includes first and second storage devices and processing resources. The first storage devices having first performance characteristics and the second storage devices having second performance characteristics different than the first performance characteristics. The processing resources manage data storage in the hybrid storage node. The first performance characteristics are higher performing than the second performance characteristics and the first storage devices include at least one high performance non-volatile memory for cache storage. The cache storage serves as cache for the second storage devices.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to illustrate various embodiments and to explain various principles and advantages in accordance with a present embodiment.

FIG. 1 depicts side-by-side block diagrams of conventional storage systems and typical proposed next generation storage systems.

FIG. 2 illustrates a block diagram of a distributed file/object based hybrid storage system in accordance with a present embodiment.

FIG. 3 illustrates a layered block diagram of an object store architecture for a single storage device in the hybrid storage system of FIG. 2 in accordance with the present embodiment.

FIG. 4 illustrates a layered block diagram of a cache architecture for a single active hybrid storage node in the hybrid storage system of FIG. 2 in accordance with the present embodiment.

FIG. 5 illustrates a layered block diagram of a shared cache architecture among multiple storage devices in the hybrid storage system of FIG. 2 in accordance with the present embodiment.

FIG. 6 illustrates a flowchart of a process flow for writing an object to object store with cache in the hybrid storage system of FIG. 2 in accordance with the present embodiment.

FIG. 7 illustrates a flowchart of a process flow for reading an object from object store with cache in the hybrid storage system of FIG. 2 in accordance with the present embodiment.

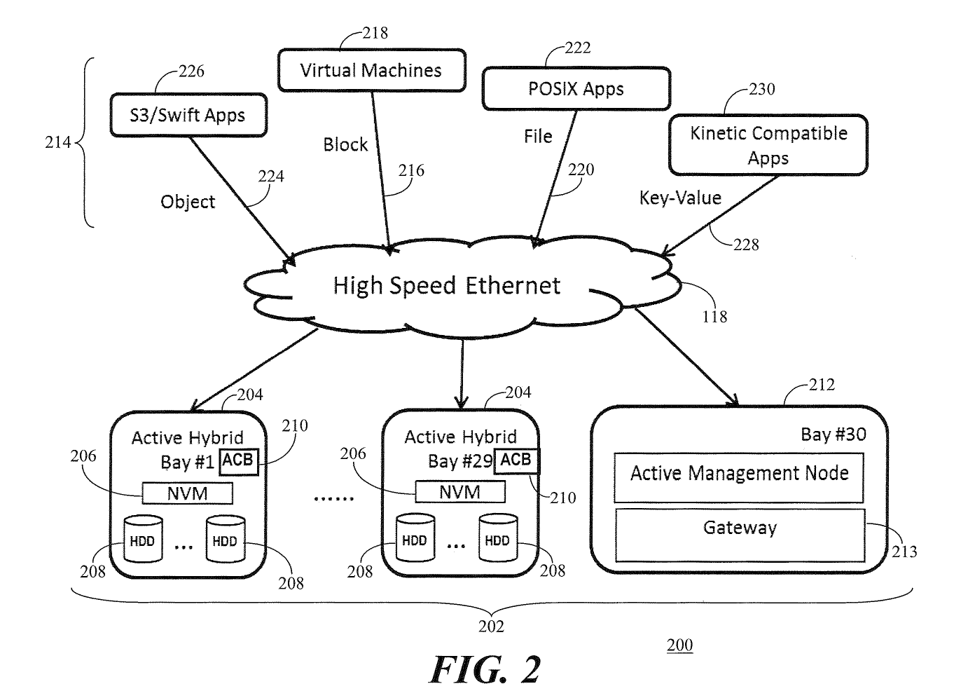

And FIG. 8 depicts an illustration of algorithms of loading and destaging objects between a hard disk drive (HDD) and cache in the hybrid storage system of FIG. 2 in accordance with the present embodiment.

Skilled artisans will appreciate that elements in the figures are illustrated for simplicity and clarity and have not necessarily been depicted to scale.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description. It is the intent of the present embodiment to present cache architecture and algorithms for hybrid storage devices in a scale-out storage cluster. A hybrid storage device in accordance with the present embodiment can be either a single hybrid drive with a non-volatile memory (NVM) chip and a magnetic disk or a group of drives with one solid state device (SSD) and one or multiple hard disk drives (HDDs).

In either form, the hybrid storage device in accordance with the present embodiment will contain a single system-on-chip (SOC) board to manage the hybrid storage medias. The SOC board in accordance with the present embodiment is typically equipped with a low power consumption processor and a certain amount of dynamic random access memory (DRAM). The SOC board may also, in accordance with the present embodiment, provide an ethernet interface that allows the hybrid storage device to directly connect to the Ethernet. The storage system cluster can be a file-based or object-based storage system, in which the data access unit will be a file or an object.

Inside the hybrid storage device in accordance with the present embodiment, the faster media (e.g., the NVM or the SSD) serves as cache for the slower media (magnetic disk). Unlike conventional cache which manages data as disk blocks, the cache architecture in accordance with the present embodiment is built on top of the file or object layer, enabling the cache to be better integrated with the upper distributed file or object storage systems. Also, the cache architecture and algorithms in accordance with the present embodiment are designed and implemented by reusing the index structures and access application programming interfaces (APIs) of the underlying file or object store. In this manner, the cache architecture in accordance with the present embodiment requires very little additional resource usage (e.g., only DRAM for metadata), to accommodate critical constraints for hybrid storage devices with limited resources.

The cache in accordance with the present embodiment is designed to be a general cache for both read and write operations, with the SOC processor providing the process flows of read and write operations and the cache loading and destaging policies and algorithms. Conventionally, the faster media inside a hybrid storage device is used to store a journal of the file/object store. In accordance with the present embodiment, the cache architecture and algorithms has several differences from conventional architectures and algorithms. First, the journal is mainly designed for supporting transactions, but this may be unnecessary since local file systems (e.g., the B-tree file system btrfs originally designed by Oracle Corporation, California USA) may already have similar functions. Using the journal in accordance with the present embodiment, the cache can improve performance on all file systems.

Second, in conventional journal design, all object writes are performed twice: the object data is written to the journal first and then the object data is written to the disk. In the cache architecture and operation in accordance with the present embodiment, only selected objects (small objects and/or hot objects) will be written to cache; all other objects are written to the disk without being written to the journal. This advantageously reduces processing time and resources because if all writes (especially the large sequential writes) go to the SSD, the limited space of the SSD resource will quickly exhausted, triggering processing-expensive flush/eviction operations.

Third, objects already committed to the journal are flushed to the disk at fixed intervals. In accordance with the present embodiment, cache entries are evicted to the disk dynamically according to various cache policies to improve overall system performance. In this manner, objects remain in the cache only as long as they are hot enough.

Fourth, conventionally journal entries are not visible to subsequent read operations because in typical systems the objects can only be read when they are written to disk. Thus, the journal may have negative impact on read performance. In the systems in accordance with the present embodiment, however, entries in cache can be accessed by read requests, thereby improving read performance. And finally, when objects in the HDD become hot, they are loaded into cache in accordance with the present embodiment to improve performance. Conventionally, objects cannot be loaded from the HDD into the journal.

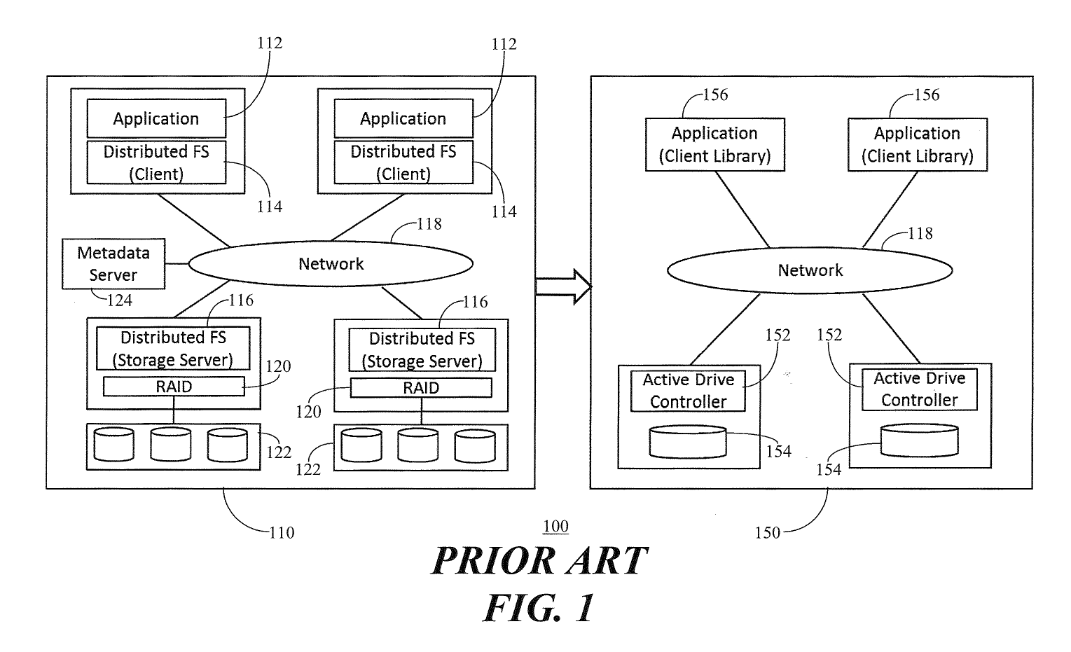

Referring to FIG. 1, a block diagram 100 shows the evolution from conventional storage systems 110 to next-generation storage systems 150. The conventional storage systems 110 include application servers 112 with client servers 114 for use in distributed file storage. The application servers 112 are coupled to storage servers 116 via a network 118. The storage servers 116 utilize redundant array of independent disk (RAID) controllers 120 to manage storage devices 122. A metadata server 124 is also coupled to the network 118 for managing metadata associated with information stored in the storage devices 122.

In the next-generation storage systems 150, the storage servers 116 and the RAID controllers used to manage the storage devices 122 have been removed. Instead, single system-on-a-chip (SOC) active drive controllers 152 are used to manage storage nodes 154 which communicate with client libraries in application servers 156 via the network 118. Thus, the functions of the storage servers 116 have been shifted to the storage devices and applications 156 can directly connect to the 154 storage devices thereby greatly reducing the storage system cost including hardware cost and maintenance cost.

The storage devices 154 of the next generation storage systems 150 are typically hybrid storage devices including different storage media in a single storage device to simultaneously improve storage performance and reduce storage cost. As discussed in the background, in order to take full advantage of the different storage media in such hybrid storage devices, efficient data management and cache algorithms are required and special requirements need to be considered. First, since the hybrid storage devices in such system are directly attached to the network, and are often managed by a distributed file or object storage system, it is more efficient for hybrid data management and cache algorithms to be designed and implemented at the file or object level. Second, as the hybrid storage devices usually have limited hardware resources, it is critical that the cache architecture and algorithms designed for such systems should be highly efficient and less resource demanding.

FIG. 2 depicts a block diagram 200 of architecture of a scale-out object storage cluster 202 in accordance with a present embodiment which addresses the challenges of the next generation storage systems. The storage nodes of the system are active hybrid bays 204. Each active hybrid bay 204 includes one solid state device (SSD) 206 and multiple hard disk drives (HDDs) 208 as storage. Each active hybrid bay 204 also includes a single SOC board called an active controller board (ACB) 210 which includes processing resources to manage the active hybrid bay 204 which can be configured as a single object storage device or configured as multiple object storage devices, with each HDD belonging to a separate object storage device. The object storage cluster 202 also includes an Active Management Node 212 which maintains the metadata for the object storage cluster 202 and includes a set of modules and processes referred to as a Gateway 213 which run in the Active Management Node 212.

The object storage cluster 202 via the high speed Ethernet network 118 provides multiple interfaces to applications 214. The Gateway 213 provides storage interfaces, such as a S3 interface, to the applications 214. A block interface 216 allows the applications 214 to use the cluster like a block device and usually uses the object storage cluster 202 to provide storage space for virtual machines 218. A file interface 220 allows portable operating system interface (POSIX) applications 222 to use the object storage cluster 202 like a POSIX file system. An object interface 224 is compatible with S3 or Swift applications 226, allowing the S3 or Swift applications to use the object storage cluster 202. A key-value interface 228 is compatible with Kinetic drive applications 230, allowing the Kinetic drive applications to use the object storage cluster 202.

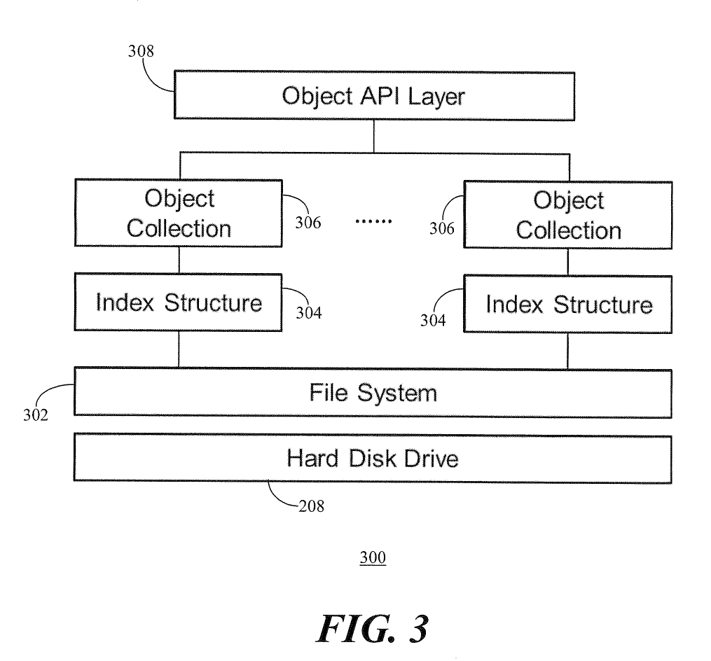

Referring to FIG. 3, a layered block diagram 300 illustrates an object store architecture for a single storage node (e.g., a hard disk drive 208) in the hybrid storage system 202 in accordance with the present embodiment. The object store is based on a local file system 302, and each object is stored as an individual file. The object store implements an index structure 304 for indexing and managing the objects. For instance, an indexing structure 304 may use hash algorithms to map the object name to an object file path name 306 and a file name in the local file system 302. An object store contains multiple collections and each collection corresponds to a separate folder containing a group of objects in the local file system 302. The object store also provides a set of POSIX-like application programming interfaces (APIs) 308, allowing the objects to be accessed from the local file system 302 like files.

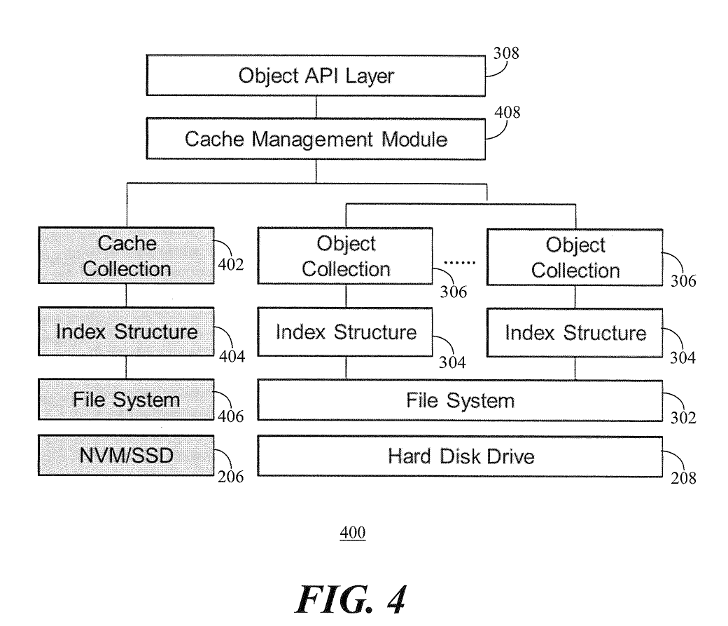

FIG. 4 illustrates a layered block diagram 400 of a cache architecture for an active hybrid storage node 204 in the hybrid storage system 202 in accordance with the present embodiment. The cache architecture is based on the object store architecture illustrated in the block diagram 300 and adds a separate cache collection 402 to the original object store. The cache collection 402 uses an index structure 404 and a file system 406 similar to the multiple index structures 304 and the file system 406. The cache collection 402 is located on faster media such as the NVM/SSD 206, while the other collections 306 are located on slower media such as the HDD 208. A cache management module 408 is implemented to manage the objects between the cache collection 402 on the NVM/SSD 206 and the object collection 306 on the HDD. The object APIs 308 are the same as the single device object store illustrated in the block diagram 300, allowing the object store applications to run on top of the cache architecture without modification. Additional cache APIs such as force destaging are implemented in the object API layer 308 for the applications to directly manipulate the data in the cache on the NVM/SSD 206.

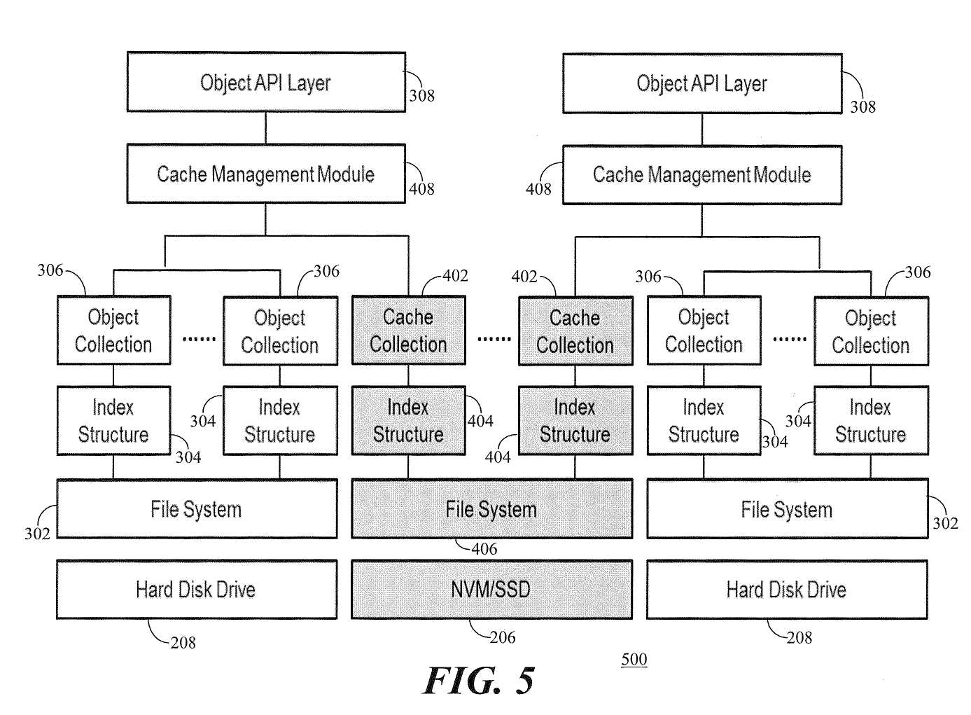

FIG. 5 illustrates a layered block diagram 500 of a shared cache architecture among multiple storage devices 208 in the hybrid storage system 202 in accordance with the present embodiment. Each cache collection 402 corresponds to a separate folder in the local file system 406 on the NVM/SSD 206. The local file system 406 may contain multiple folders, and each corresponds to a different cache collection. While these cache collections share the same file system space, they each belong to a different object store file system 302 on different HDDs 208.

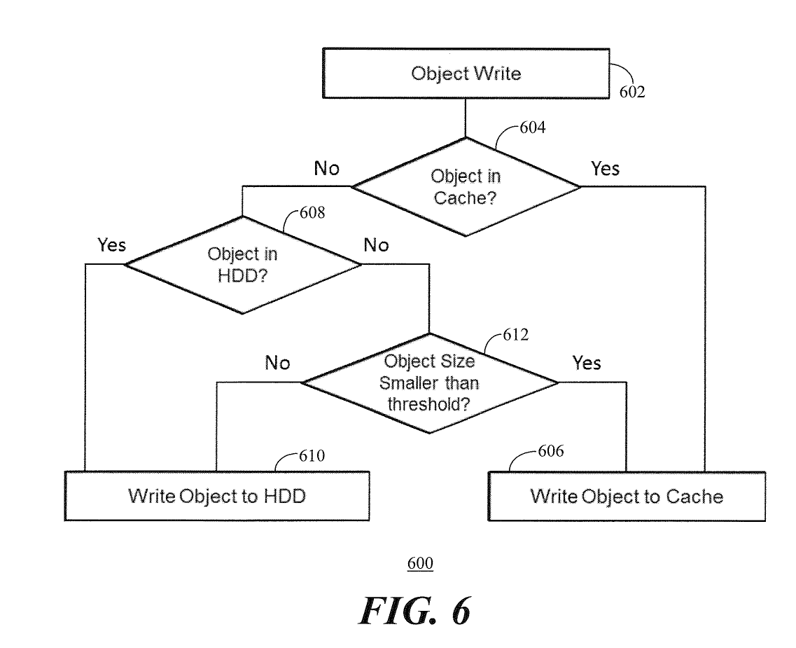

FIG. 6 illustrates a flowchart 600 of a process flow for writing an object to object store with cache in the hybrid storage system 202 in accordance with the present embodiment. Upon receiving an object write request 602, the cache management module 408 first detects 604 if the object is already in the cache collection 402, and if it does, performs 606 an update to the object in the cache. If the object is not in the cache 604, the cache management module 408 further detects 606 if the object exists in the HDD 208. If the object is stored 606 in the HDD 208, it will be updated 608 in the HDD 208 directly. Otherwise, the object is a new object and it is written 606 to the cache or written 608 to the HDD 208 according to object size, name, type, or other object attributes 610.

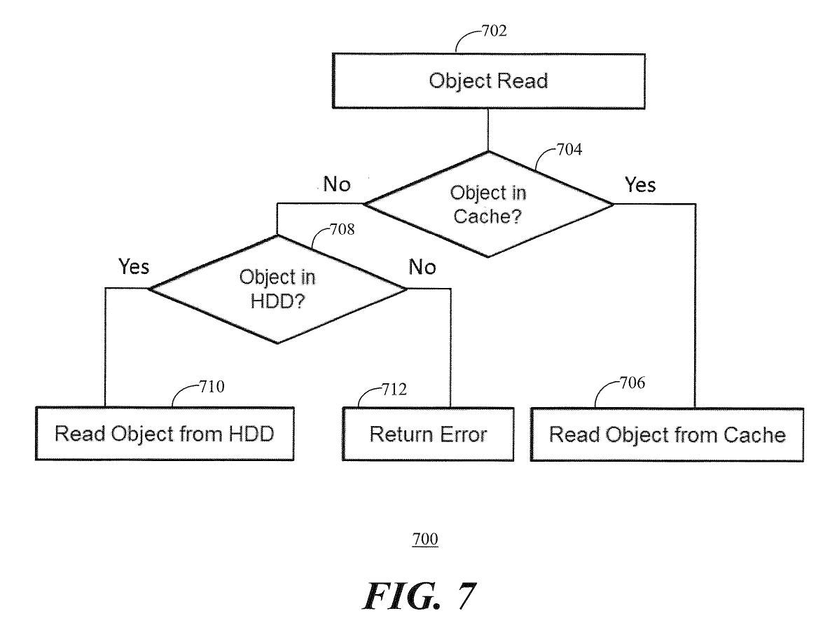

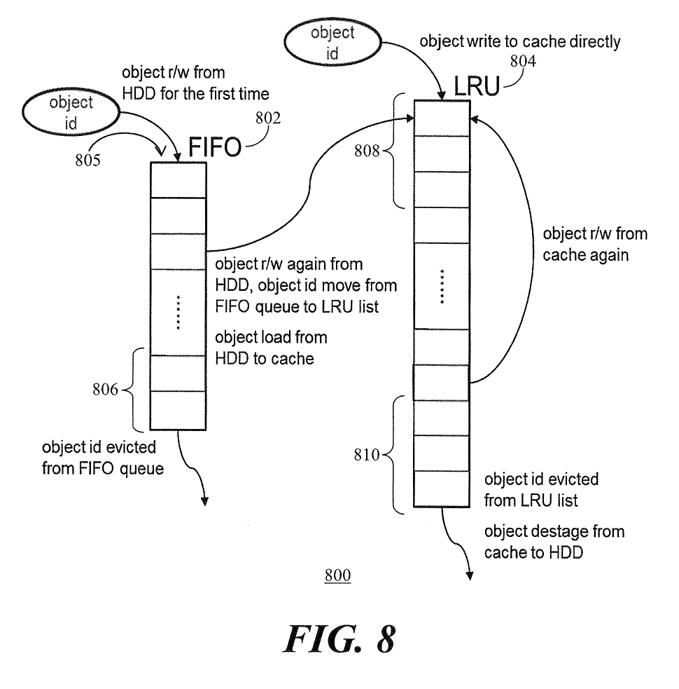

Referring to FIG. 7, a flowchart 700 illustrates a process flow for reading an object from object store with cache in the hybrid storage system 202 in accordance with the present embodiment. When an object read request 702 is received, the cache management module 408 first detects 704 if the object is in the cache collection 402. If it does, it is read 706 from the cache. If it is detected 708 that the object is in the HDD 208, it is read 710 from the HDD 208. If the object is not detected 704, 708 in either the cache collection 402 or in the HDD 208, an error is returned 712 by the cache management module 408 to the object API layer noting that the object is not stored in the file systems 302, 406 accessible by the cache management module 408.

FIG. 8 depicts an illustration 800 of algorithms of loading and destaging objects between the HDD 208 and NVM 206 cache in the hybrid storage system 202 in accordance with the present embodiment. The cache management module 408 implements two metadata structures: a FIFO queue 802 and a LRU list 804. The FIFO queue 802 serves as a short history buffer storing the object ids which have been accessed once from the HDD 208 during a predetermined recent period of time, the object ids being stored at a head 805 of the FIFO queue 802. If an object in the FIFO queue 802 is accessed for a second time, it will be loaded from the HDD 208 to the cache in the NVM 206. If an object in the FIFO queue 802 is never accessed again, it will be gradually moved to a tail 806 of the FIFO queue 802 and eventually evicted from the FIFO queue 802 as new objects are coming into the queue. In fact, the FIFO queue 802 acts as a filter that prevents the objects which are accessed only once during a long time duration from coming into the cache, thus advantageously avoiding cache pollution and reserving cache space for truly hot objects. On the other hand, the LRU list 804 is usually much larger than the FIFO queue 802, and the LRU list 804 stores the object ids which are currently in the cache. Whenever an object comes into the cache, its object id is added at a head 808 of the LRU list 804. If an object in the LRU list 804 is accessed again, it is moved back to the head 808 of the LRU list 804. In this way, the frequently accessed hot objects remain at the head 808 of the LRU list 804, and the colder objects move to a tail 810 of the LRU list 804.

When an object in the cache in the NVM 206 is updated after it was copied from the HDD 208 after it was copied into the cache in the NVM 206, the object is referred to as a “dirty object” because the cache has a newer version of the object stored in the NVM 206 than the HDD 208. A “clean object”, on the other hand, is an object in the cache in the NVM 206 that has not been updated since it was copied from the HDD 208 into the cache. Thus, during cache destage, objects from the tail 810 of the LRU list 804 will be evicted from cache and written to the HDD 208 if they are dirty objects, since the cache version of the dirty objects are newer versions of the objects than the HDD-stored versions of the dirty objects. Clean objects, however, will be evicted from cache without being written to the HDD 208 as the HDD-stored version of the clean object is the same as the cache version of the clean object.

In accordance with one aspect of the present embodiment, the cache can be implemented with an in-memory LRU list 804. However, the cache can also be implemented in accordance with another aspect of the present embodiment without an in-memory LRU list 804. This is because the cache in accordance with the present embodiment is at the object/file level and the access/modification time of stored objects are already recorded by the underneath file system. By utilizing file system information and sorting the objects/files by access/modification time, the cache can achieve similar effects as the in-memory LRU list 804. In a practical implementation, one can also implement an in-memory LRU list 804 in accordance with the present embodiment but not back up the LRU list 804 in a persistent storage because, in case of a system crash, the in-memory LRU list 804 can be recovered from the file system information 302, 406.

In accordance with another aspect of the present embodiment, a cache destage operation may be scheduled according to current cache space utilization and workload state. Two thresholds for cache space utilization can be set, a lower threshold and an upper threshold. If the current cache space utilization is under the lower threshold, no cache destage need be scheduled. If the current cache space utilization is above the lower threshold but below the upper watermark, the cache destage can be scheduled when the system 202 is idle. And if the current cache space utilization is above the upper threshold, cache destage should be scheduled with high priority.

Thus, it can be seen that the present embodiment provides improved methods for data storage and data storage systems for efficient hybrid data management and cache algorithms which overcome, at least partially, the drawbacks of conventional approaches and provide minimal resource usage solutions for effective use in future storage systems.

While exemplary embodiments have been presented in the foregoing detailed description of the invention, it should be appreciated that a vast number of variations exist. It should further be appreciated that the exemplary embodiments are only examples, and are not intended to limit the scope, applicability, operation, or configuration of the invention in any way. Rather, the foregoing detailed description will provide those skilled in the art with a convenient road map for implementing an exemplary embodiment of the invention, it being understood that various changes may be made in the function and arrangement of steps and method of operation described in the exemplary embodiment without departing from the scope of the invention as set forth in the appended claims.

1. A method for data storage in a hybrid storage node of a data storage system, the hybrid storage node comprising first and second storage devices having different performance characteristics wherein the first devices comprise at least one high performance non-volatile memory for cache storage and the second storage devices comprise two or more storage devices, the cache storage being shared among the two or more storage devices, the hybrid storage node further comprising processing resources shared among the two or more storage devices for managing data storage in the hybrid storage node so as to implement the method, the method comprising:
receiving a read request to read stored information from the hybrid storage node; and
in response to the read request, accessing both the cache storage in the first storage devices and storage in the second storage devices to locate the stored information using the shared processing resources.

2. The method in accordance with claim 1 further comprising:
receiving a write request to write information to the hybrid storage node;
in response to the write request, writing the information to the second storage devices; and
in response to the write request, writing the information to the cache storage only if the information meets predetermined criteria.

3. The method in accordance with claim 2 wherein the predetermined criteria comprises one or more of a size of the information is below a predetermined size threshold and the information comprises hot data.

4. The method in accordance with claim 3 wherein the cache storage comprises id queue storage which stores identification information associated with data in the id queue storage each time the data is accessed and wherein information comprises hot data when the information comprises data which has associated identification information stored to the id queue storage when the associated identification information is already stored in the id queue storage.

5. The method in accordance with claim 3 further comprising in response to locating the stored information in the storage in the second storage devices, writing the stored information to the cache storage if it is not already stored in the cache storage and if the stored information comprises hot data.

6. The method in accordance with claim 1 further comprising performing cache flushing only when predetermined criteria is met, wherein cache flushing comprises deleting data form the cache which is not hot data.

7. The method in accordance with claim 6 wherein the predetermined criteria comprises criteria selected from (a) cache space utilization is greater than a first threshold and (b) cache space utilization is below the first threshold but above a second threshold and the hybrid storage node is idle.

8. A data storage system comprising one or more hybrid storage nodes, each hybrid storage node comprising:
first storage devices having first performance characteristics;
second storage devices having second performance characteristics different than the first performance characteristics; and
processing resources for managing data storage in the hybrid storage node,
wherein the first performance characteristics are higher performing than the second performance characteristics, and wherein the first storage devices comprise at least one high performance non-volatile memory for cache storage, and wherein the cache storage serves as cache for the second storage devices, and wherein the second storage devices comprise two or more storage devices, and wherein the processing resources and the cache storage are shared among the two or more storage devices.

9. (canceled)

10. The data storage system in accordance with claim 8 wherein the first and second performance characteristics comprise data access speeds, and wherein the first performance characteristics comprise faster access speeds than the second performance characteristics.

11. The data storage system in accordance with claim 8 wherein the processing resources access the cache storage for both read and write operations.

12. The data storage system in accordance with claim 8 wherein the processing resources include an id queue storage and an id list storage, and wherein the id queue storage comprises a short history buffer storing data identification information which has been accessed from the second storage devices during a predetermined recent period of time, and wherein the id list storage comprises larger storage than the id queue storage, and wherein the processing resources perform cache loading and cache destaging policies in response to the id list storage.

13. The data storage system in accordance with claim 12 wherein the id list storage can be implemented in the first storage devices and can serve as the cache storage.

14. The data storage system in accordance with claim 12 wherein the information associated with data in the id queue storage is read from the second storage devices and stored to the cache storage in response to the associated data in the id queue storage being accessed more than once.

15. The data storage system in accordance with claim 12 wherein the information associated with data in the id list storage is evicted from the cache storage in response to the associated data in the id list storage not being accessed and moving to the end of the id list storage.

16. The data storage system in accordance with claim 8 wherein cache architecture reuses an index structure of each of the second storage devices.

17. The data storage system in accordance with claim 8 wherein the first storage devices comprise non-volatile memory devices.

18. (canceled)

19. The data storage system in accordance with claim 8 wherein the second storage devices comprise one or more storage devices, each comprising either hard disk drive storage media or a solid state storage device.

20. The data storage system in accordance with claim 8 wherein the processing resources comprise a system-on-a-chip comprising a processor and memory resources for at least metadata storage and/or the processing resources comprise a network interface for interfacing over a network with applications.

21. (canceled)

22. The data storage system in accordance with claim 20 wherein the processing resources comprise a network interface, and wherein the network interface couples with one or more of a block interface, a file interface, an object interface or a key-value interface.

23. The data storage system in accordance with claim 8 wherein the data storage system is either file-based or object-based, and wherein when the data storage system is file-based each data access unit is a file, and wherein cache architecture of the cache storage is built on top of a file layer shared by the first and second storage devices, and wherein when the data storage system is object-based, and wherein when each data access unit is object-based the cache architecture of the cache storage is built on top of an object layer shared by the first and second storage devices.

24. (canceled)
